(19) United States
(12) Patent Application Publication
(10) Pub. No.: US 2025/0313440 A1
(43) Pub. Date: Oct. 9, 2025

(54) ELECTRIC MAST

(71) Applicant: Cascade Corporation, Fairview, OR (US)

(72) Inventors: Christopher M. WALTHERS, Gresham, OR (US); Brent G. RUNNING, Hood River, OR (US); Mark Anthony BEESLEY, Seneca, SC (US); Lorenzo VAGHINI, Piacenza (IT); Brady Adam BAUER, Seneca, SC (US)

(73) Assignee: Cascade Corporation, (omitted)

(21) Appl. No.: 19/084,213

(22) Filed: Mar. 19, 2025

Related U.S. Application Data
(60) Provisional application No. 63/567,796, filed on Mar. 20, 2024.

(51) Int. Cl. B66F 9/10; B66F 9/24

(52) U.S. Cl. CPC B66F 9/10; B66F 9/24

(57) ABSTRACT

An electrically powered mast for a lift truck that includes one or more electrically powered actuators positioned within an outermost periphery of a vertically elongate frame of the mast, and selectively moving a carriage along the vertically elongate frame.

### CROSS REFERENCE TO RELATED APPLICATIONS

This application claims the benefit of U.S. Provisional Patent Application No. 63/567,796 filed Mar. 20, 2024, the contents of which are hereby incorporated by reference in their entireties.

### BACKGROUND

The subject matter of this application generally relates to masts for lift trucks.

A lift truck typically is a battery-powered vehicle having an operator compartment with controls that enable the operator to hoist materials and carry them while driving the truck throughout a factory, warehouse, etc. An upright mast, often telescopic, is attached to the forward end of the truck and includes a sliding carriage to which forks or other lift truck attachments such as clamp arms may be attached to the mast. Telescopic masts have both “free lift” and “main lift” stages; the “free lift” stage refers to the operation of carriage as it translates along the mast, whereas the “main lift” stage further telescopes the mast vertically. There are many different types of attachments to which a lift truck may be engaged, each of which have a different operation. For example, some attachments have merely a single pair of forks, while others have multiple pairs to enable a lift truck to carry multiple pallets of goods at once. Still other lift trucks have clamp arms rather than forks, which are intended to grasp cylindrical loads, and the category of clamp attachments itself includes many varieties that may or may not include rotation, tilting, etc.

Thus, as can easily be appreciated, lift trucks and lift truck attachments have separate control systems, meaning that lift trucks are constructed with their own actuator(s) for raising and lowering the mast, while lift truck attachments are similarly constructed with their own actuators tailored to the specific operation of the attachment. But during use, these disparate operations must be coordinated. As one example, when a lift truck is to move a pallet of goods in a warehouse, the lift truck must lower the carriage so that the forks of the attachment are level with lateral openings in a pallet resting on the ground, and the forks of the lift truck must similarly be positioned horizontally to be aligned with the openings of the pallet. As another example, when a lift truck with a clamp attachment is to move a paper roll in a warehouse, the lift truck must vertically position the carriage and horizontally position the clamp arms so that the clamp arms may approach the paper roll at a vertically-centered position relative to the paper roll with the clamp arms surrounding it. Then the clamp arms must be moved inward to grasp the paper roll with a force sufficient to enable it to be lifted, but not so great as to damage the roll. Then the carriage of the mast must be raised for transporting the paper roll to its destination where it is to be lowered and released.

Both the operation of the mast and the operation of the attachment, though separately implemented, are to be controlled by the operator of a lift truck, which essentially means that regardless of the independent design of the attachment's operation, it's control must ultimately trace back to the lift truck. Historically, the control of the lift truck and the attachment has been provided hydraulically via a pump and a reservoir located on the lift truck. Thus, while the lift truck and the attachment have independent hydraulic actuators i.e., one or more actuators to raise and lower the mast and one or more actuators to operate the attachment, both the fluid supply and the control signals for the attachment originate at the lift truck. This necessitates hoses that extend over the mast to supply the attachment with fluid. Also, some attachments are controlled electrically with e.g., solenoid valves which often is implemented using electrical lines that also extend over the mast to provide power and signals to the electrical components of the attachment.

These hoses and electrical lines introduce several drawbacks. First, these components frequently impede the view of a lift truck operator, who often must see the load that is being approached or positioned upon release. Second, since many masts are telescopic, the movement of the mast causes wear on the hoses and electrical lines. With respect to the electrical lines, many recent attachments provide independent batteries to power the operation of some electrical components on the attachments, but these batteries need to be recharged. Still other recent attachments utilize RF or other electromagnetic control signals from the lift truck to the attachment. Thus, while some hydraulic attachments have been able to eliminate the need for electrical lines to extend over the mast, hydraulic hoses still must be used to supply fluid to the cylinders that operate forks, clamp arms, etc. of hydraulic attachments.

What is desired, therefore, are improved devices and systems for enabling lift trucks to operate a wide variety of attachments without necessitating hoses or potentially also electrical lines over the mast, and without obstructing the view of an operator.

### BRIEF DESCRIPTION OF THE DRAWINGS

For a better understanding of the invention, and to show how the same may be carried into effect, reference will now be made by way of example to the accompanying drawings, in which:

FIG. 1 shows exemplary speed characteristics of a typical existing hydraulic mast.

FIG. 2 shows an exemplary prior art electric mast.

FIG. 3A shows an improved electric mast as described in the present specification.

FIG. 3B shows an enlarged view of the mast of FIG. 3A with a pulley system.

FIG. 3C shows the view of mast 3A along line A-A of FIG. 3B.

FIG. 4 shows an exemplary electric actuator of the electric mast of FIGS. 3A to 3C.

### DETAILED DESCRIPTION

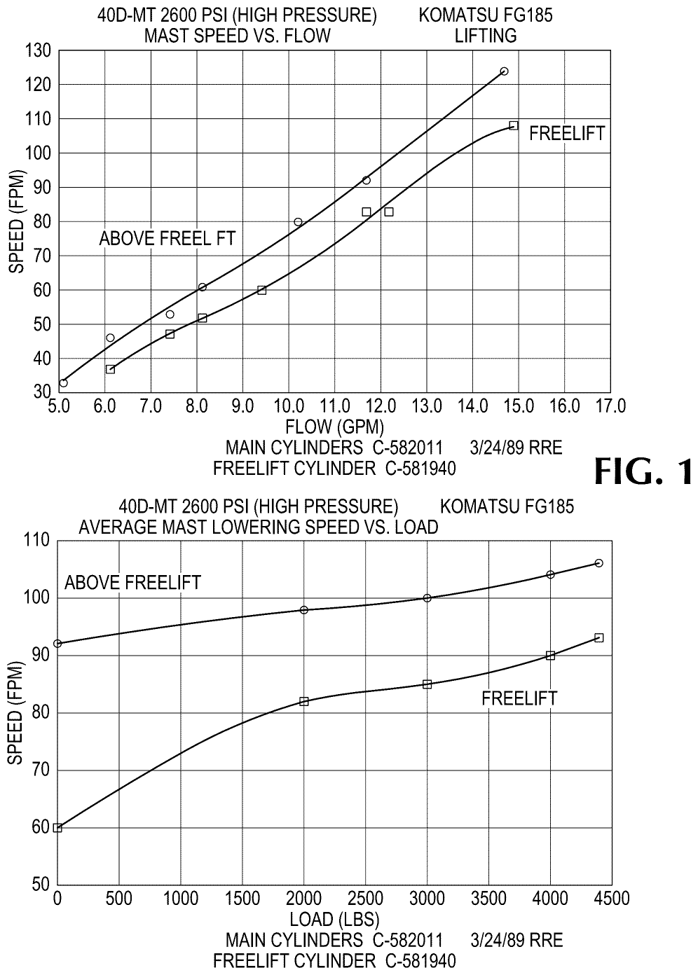

As noted previously, existing lift trucks typically utilize hydraulic power and control circuits to raise and lower the carriage of the mast of the lift truck, as well as to power and control attachments to the lift truck. Use of hydraulic power and control systems is advantageous because of its power density. Referring to FIG. 1, for example, hydraulically powered list trucks are able to lift very heavy loads of upwards of 4000 lbs at speeds of over 120 feet-per-minute in both free lift and main lift stages, while providing 15 gallons-per-minute of fluid or less. This power efficiency provides for the productive operation of the lift trucks as loads may be grasped, lifted, maneuvered, lowered, and released in relatively short time frames.

As also noted previously, hydraulically operated lift trucks have disadvantages in that the hoses often interfere with an operator's view of the load during operation, and the telescoping operation of a mast causes wear on the hoses and any electrical connections between the lift truck and its attachment. Some attachments provide for electrical actuation and control of the attachment function, and such attachments ameliorate these disadvantages as electrical lines, and sometimes hydraulic hoses, no longer need to be provided to the attachment.

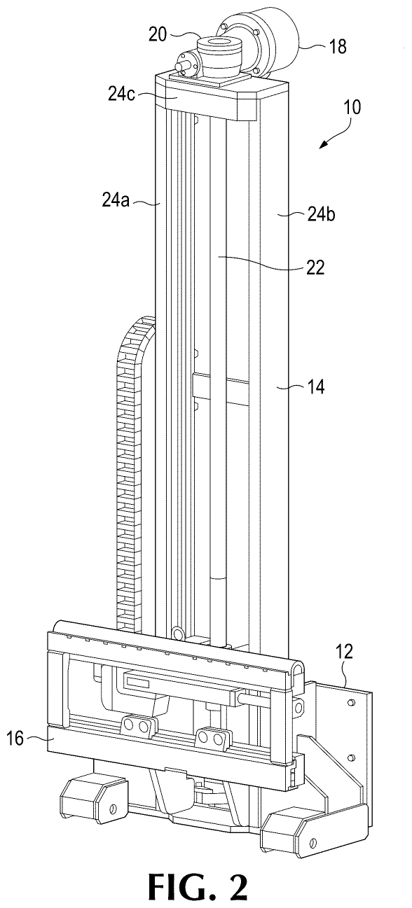

Similarly, there has been a push for electrically-actuated masts of lift trucks, rather than hydraulically actuated masts. Thus, instead of one or more hydraulic actuators providing the actuating force for vertical movement of the mast of a lift truck, an electric motor is used instead. FIG. 2 shows an existing electric mast 10, which includes a mounting plate 12 affixed to a vertically-elongate frame 14 upon which a carriage 16 translates in an up-and-down movement. The plate 12 may be affixed to a lift truck that provides electrical power to a motor 18 positioned at the top of the frame 14. The motor 18 in turn drives or rotates a ball screw 22 through a gear assembly 20. The ball screw 22 comprises a threaded outer surface to which the carriage 16 is engaged. The carriage 16 is also slidably engaged with opposed lateral rails 24a and 24b of the frame. Because this arrangement prevents rotation of the carriage 16, as the ball screw 22 rotates, its threaded engagement with the carriage 16 causes the carriage to translate either up or down the frame 14 depending on which direction the ball screw 22 rotates. The mast 10 may also include a wire guide 25 for electrical cable management.

Electrically actuated masts, such as the mast 10, however, have a number of substantial disadvantages relative to hydraulic masts. First, the central positioning of the ball screw 22 interferes with the view of an operator of the lift truck. Thus, even when the lift truck is engaged with an electrically actuated attachment that requires no hydraulic hoses or lines to the attachment, the electric mast itself will block the view of the attachment as it manipulates a load. Second, to drive the central shaft, the motor 18 is necessarily positioned above the top horizontal rail 24c of the frame 14, in an offset position relative to the centerline of the frame 14 so as to drive the shaft 14 via the gear assembly 20. The motor is typically heavy, and the off-center positioning above the mast reduces the stability of the lift truck to which it is attached because of the moment of inertia imparted by the motor 18. This, in turn, limits the capabilities (tilt, side-shift) of many attachments to which the mast may be connected. Furthermore, the motor 18 limits the lift height of any other stages of the mast, and also limits the clearance of the load as the motor might hit the top of a trailer into which the load is to be inserted, for example.

Third, the single-rail design of the mast 10 limits lift heights. Although other stages of an electric mast may theoretically be added to this design, these stages would necessitate another motor and drive shaft, exacerbating the disadvantages described in the preceding paragraph. Moreover, the motor 18 is not as efficient in power delivery as hydraulically operated masts. Even the large and heavy motor 18 shown in FIG. 2 is only capable of providing the carriage 16 with a speed of about 150 mm per second, which is approximately one quarter of the speed at which hydraulically-driven masts operate. Again, in principle this problem could be overcome by using even larger and heavier motors, but this again would exacerbate the disadvantages described in the preceding paragraph. Finally, the environmental exposure of the components of mast 10 and particularly the ball screw 22 is of concern as grease etc. can attract dust since ball screws may not be enclosed. Alternatively, bellows may be included to cover the ball screw assembly, but this limits the stroke of the mast.

The present specification discloses an improved electric mast assembly that solves the foregoing drawbacks of existing electric masts. First, the present specification discloses an electric mast with electric actuators positioned within the frame of the vertically elongate mast, rather than above (or below) it as is done with respect to existing electric masts. In this manner, the novel electric masts disclosed in the present specification provide for better weight balance of the lift truck to which the mast is attached. Second, rather than utilizing a centrally-positioned ball screw driven by an electric motor, embodiments of the disclosed electric mast include one or more electric actuators that are driven by a motor within a compact housing of the actuator. Such a design beneficially obviates the need for a centrally-positioned ball screw that obstructs the view of a lift truck driver. The disclosed actuators in turn, because they are compact, permit them to be positioned laterally within the frame of the mast, so that they themselves do not obstruct a driver's view. Furthermore, the compact design of the disclosed actuators allows the mast to be driven by multiple actuators, with their individual motors, rather than a single large motor. Thus, the disclosed, electrical actuator driven electric mast has performance characteristics that exceed that of existing electric masts as will be disclosed in further detail below.

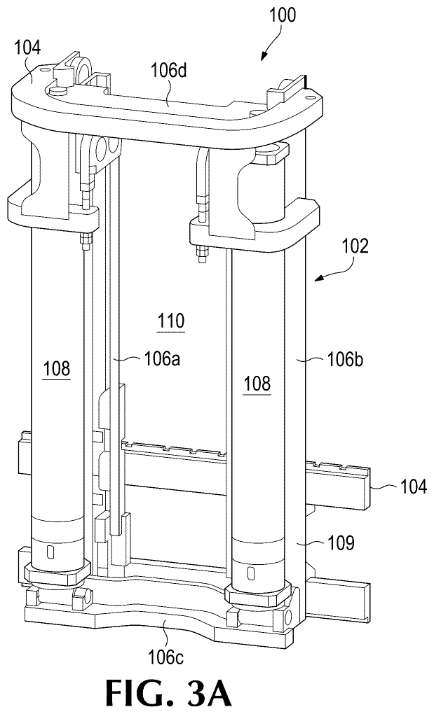

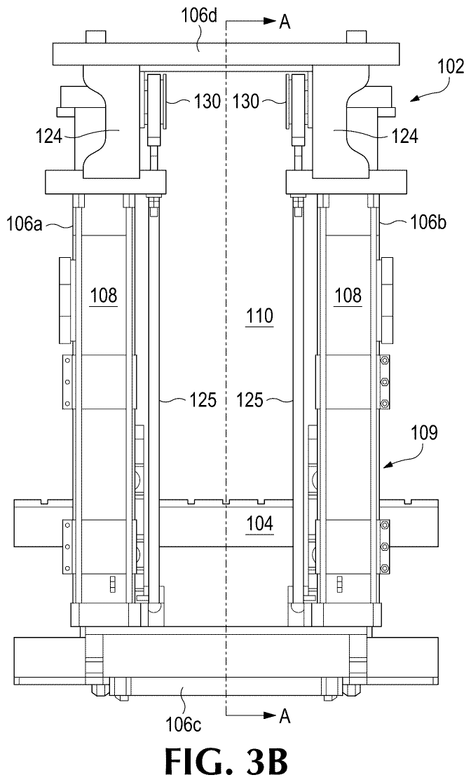

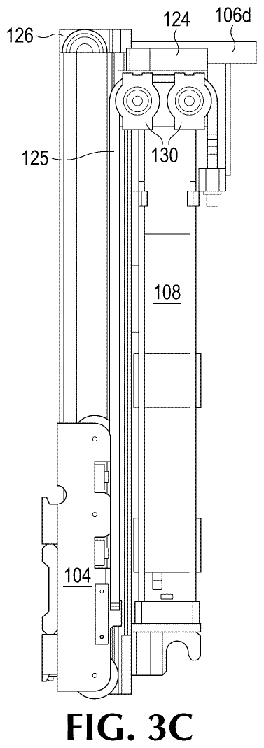

FIG. 3A shows an exemplary electric mast 100 that incorporates the features just described. Specifically, the electric mast 100 may have a vertically-elongate frame 102 to which a carriage 104 is slidably connected so that the carriage 104 may selectively translate up and down the carriage 104. The frame 102 may be composed of outermost lateral supports 106a, 106b transversely spaced from each other to define a width of the frame, and outermost bottom and top supports 106c and 106d, respectively, vertically spaced from each other to define a height of the frame. Together the supports 106a, 106b, 106c, and 106d define an outermost periphery 109 of the frame 102 upon which the carriage 104 translates.

The electric mast 100 also includes two electric actuators 108, the construction of which will be described in more detail later in this specification. The electric actuators are preferably of identical construction and preferably positioned within the outermost periphery 109 of the frame 102, and more preferably each positioned proximate one of the lateral supports 106c and 106d. In this manner, the actuators do not obstruct a view through a central opening 110 of the electric mast 110, while simultaneously balancing the weight of the electric mast 100 so as to provide more stability to a lift truck/attachment connected to the mast, and thereby facilitate a wide range of tilt, side shift, lateral acceleration etc. of any attachment connected to the mast. The electric actuators 108 raise and lower the carriage 104 as described in more detail below.

The electric mast 100 shown in FIG. 3 has dramatically better performance than existing electric masts such as those shown in FIG. 2. Specifically, in some embodiments the electric mast 100 may preferably lift a total weight (inclusive of the load, attachment, and chains) of up to 2000 kg while attaining a maximum speed, for both raising and lifting the load, that is significantly greater than what the electric mast of FIG. 2 can achieve. Preferably, for example, the electric mast of FIG. 3 may achieve a speed of at least 200 mm per second when lifting heavy loads e.g., up to 2000 kg. More preferably, the electric mast of FIG. 3 may achieve a speed of at least 400 mm per second when lifting such heavy loads, and in still further embodiments may achieve a speed within the range of 575-650 mm per second, which is comparable to that of a hydraulic mast i.e., 118 feet per minute (600 mm/s), as can be seen in FIG. 1. The lift height of the carriage 104 is approximately three feet (1000 mm).

The electric mast 100 of FIG. 3, as explained later in this specification, is a standard mast with limited free lift, the disclosed actuators and embodiments described in the specification may be used with electric masts having two or more stages. For example, a three-stage mast employing the embodiments of the present disclosure may lift a total weight (load, attachment, chains) of 2000 kg while retaining the maximum speeds as described earlier, e.g., 600 mm/s, but have a total lift height of over 15 feet (4775 mm), the free lift height comprising approximately 5 feet of that (1484 to 1568 mm).

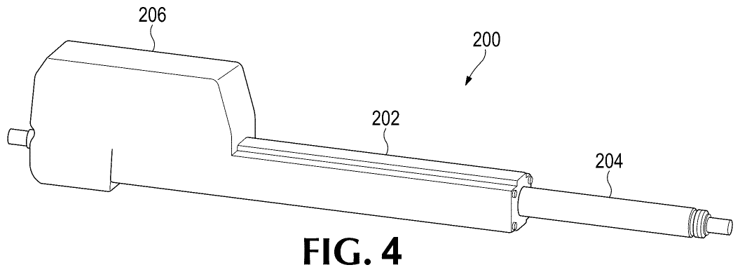

As noted previously, the disclosed electric mast 100 achieves speeds not previously attainable by electric masts. This is accomplished by several features of the mast 100. First, as noted earlier, the design of the mast 100 includes two actuators and thus two motors, providing increased power and speed. Second, referring for example to FIGS. 3B and 3C, the electric mast 100 may comprise a standard mast with limited free lift in which the mast 100 includes longitudinally extensible frame section 124 slidably mounted to a rail member 126. The electric actuators 108 include a rod (e.g., rod 204 of FIG. 4) that is affixed to the frame section 124 to alternately raise and lower the frame section 104 along the rail member 126. Each of two chains 125 extend around a respective pully system 130 that is in turn rigidly affixed to the frame section 124. Each chain 125 is affixed at one end to the carriage 104 and at the other end to the outer frame of the mast 100. Thus, as can be seen in these figures, when the electric actuators 108 raise (or lower) the frame section 124, the carriage 104 must rise (or fall) at twice the rate of the frame section 124 due to the fixed lengths of the chains 125. In other words, the carriage 104 achieves twice the linear displacement that the respective motors of the electric actuators 108 provide to those actuators. Further still, the speed of the mast 100 may be enhanced by using electric actuators with motors that have a high power density i.e., electric motors that achieve very high torque using relatively small, but powerful magnets/coils.

Because the movement of the carriage 104 along the mast 100 is not independent of the longitudinally extensible frame of the mast 100, the mast 100 is referred to as a standard mast with “limited” free lift. As noted earlier, however, alternate embodiments of electric masts consistent with the disclosure of the present application may include multistage masts, such as two or three-stage masts with independent free lift capabilities by, for example, including more electric actuators 108 so as to move the carriage along a mast independently of the extensibility of the mast itself.

FIG. 4 shows an actuator 200 that includes a motor that drives a rod 204 via a gear assembly. Specifically, the actuator 200 may comprise an outer enclosure 202 from which a shaft 204 slidably extends by operation of a motor enclosed within a chamber 206 of the actuator 200. Also enclosed within the chamber 206 is a gear assembly that transfers force from the motor to the rod 204.

In some preferred embodiments, the disclosed mast 100 may regenerate energy as the carriage 104 is lowered. Specifically, the mast 100 and its actuators/motors may be configured such that gravity causes the carriage 104 to move downwards along the mast 100 and thereby drive the motor to operate as a generator.

Preferably, in some embodiments a braking mechanism may be selectively applied to the motor 114, which is provided with breaking power twice that of the motor output. 2

Optionally, the electric mast could be provided with a feedback transducer to measure load weight. This could be supported by Belleville (spring) washer sets and could provide feedback to vary power based on the weight of the load, possibly automatically. Also, the electric mast 100 can optionally be utilized in sit down, walkie, and stand-up rider trucks. Optionally, the electric mast will allow for a tilt function of the load, and in some embodiments will allow a transfer from tilting the mast to tilting the carriage. Optionally the electric mast could be utilized in several types of vehicles, mast types (single, dual, triple, quad and five stage) and capacity ranges.

Those skilled in the art will appreciate that the electric drive of the mast described herein could also be utilized in high powered compact motor for rotator applications, such that the traditional worm drive gear box could be eliminated completely. Used in rotators, this would have the advantage of reducing noise coming off the rotator either from hydraulic motor or from gear box. It would be possible to configure a rotator without a worm screw and without a worm wheel; rather, the electric motor could be directly coupled to the rotation.

Those of ordinary skill in the art will also appreciate that the embodiments of an electric mast disclosed in the present specification could be adapted for use in driverless Automated Guided Vehicles (AGVs). Similarly, although a single-stage mast is depicted in FIG. 3, the electric actuators disclosed in the present specification could be used in a multi-stage mast, such as a 2-stage or 3-stage mast.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A mast selectively attachable to a lift truck and having a vertically-elongate frame with an outermost periphery defined in part by opposed vertical members spaced laterally from each other and rigidly interconnected to each other by an uppermost horizontal member, the mast comprising:
a carriage; and
at least one electrically powered actuator positioned below the upper, horizontal member and which that translates the carriage in an alternatingly up or down movement along the opposed vertical members.

2. The mast of claim 1 where the frame includes a lowermost, vertical member that rigidly interconnects the opposed vertical members, and the at least one electrically powered actuator is positioned above the lowermost horizontal member.

3. The mast of claim 2 where the at least one electrically powered actuator is positioned at least in part between the opposed vertical members.

4. The mast of claim 1 where each of the at least one electrically powered actuator is configured to regenerate energy when the carriage is lowered.

5. The mast of claim 1 including a braking mechanism.

6. The mast of claim 1 where each at least one electrically powered actuator includes a casing that encloses a motor.

7. The mast of claim 1 where the vertically elongate frame defines a central opening that is free from visual obstructions between the carriage and an operator of a lift truck to which the mast is selectively attached.

8. The mast of claim 1 free from a ball screw that moves the carriage.

9. A mast selectively attachable to a lift truck and having a vertically-elongate frame and a carriage selectively translatable along the frame, the mast comprising at least one electrically powered actuator capable of translating the carriage in an alternatingly up or down movement along the frame at a speed of at least 200 mm per second when the carriage supports a load of 2000 kg.

10. The mast of claim 9 where the at least one electrically powered actuator is capable of translating the carriage in an alternatingly up or down movement along the frame at a speed of at least 400 mm per second when the carriage supports a load of 2000 kg.

11. The mast of claim 10 where the at least one electrically powered actuator is capable of translating the carriage in an alternatingly up or down movement along the frame at a speed of between 575 mm per second and 650 mm per second when the carriage supports a load of 2000 kg.

12. The mast of claim 9 having two said electrically powered actuators.

13. The mast of claim 9 where the vertically elongate frame defines a central opening that is free from visual obstructions between the carriage and an operator of a lift truck to which the mast is selectively attached.

14. The mast of claim 9 free from a ball screw that moves the carriage.
